(19) United States
(12) Patent Application Publication
(10) Pub. No.: US 2017/0270755 A1
(43) Pub. Date: Sep. 21, 2017

(54) LIGHT EMITTING ACCESSORY FOR PORTABLE TERMINAL, AND ACCESSORY LIGHT EMITTING SYSTEM FOR PORTABLE TERMINAL

(71) Applicant: HYSONIC. CO., LTD., Ansan-si Gyeonggi-do (KR)

(72) Inventors: Sang Won JEONG, Ansan-si, Gyeonggi-do (KR); Hyun Wook LEE, Ansan-si, Gyeonggi-do (KR); Bang Sik DONG, Ansan-si, Gyeonggi-do (KR); Young Gi HONG, Ansan-si, Gyeonggi-do (KR); Hee Min YANG, Ansan-si, Gyeonggi-do (KR); He Won JUNG, Ansan-si, Gyeonggi-do (KR)

(21) Appl. No.: 15/329,849

(22) PCT Filed: Feb. 15, 2016
(86) PCT No.: PCT/KR2016/001494

§ 371 Date: Jan. 27, 2017

(30) Foreign Application Priority Data
Apr. 29, 2015 (KR) 10-2015-0060268

(51) Int. Cl. G08B 5/38; G09F 13/12; H04B 17/23; H05B 37/02; F21V 17/00

(52) U.S. Cl. CPC G08B 5/38; H05B 37/0272; F21V 17/002; H04B 17/23; G09F 13/12; F21W 2121/00

(57) ABSTRACT

The present invention relates to a light emitting accessory for a portable terminal and an accessory light emitting system for a portable terminal, and to a light emitting accessory for a portable terminal, which is detachably coupled to the portable terminal to emit light using light of a flash of the portable terminal based on an external signal, a location of the portable terminal, and the like, and an accessory light emitting system for a portable terminal. A light emitting accessory for a portable terminal according to the present invention includes: a fixing unit that is detachably coupled to a portable terminal to cover a flash that is formed on a rear surface of the portable terminal; and a light emitting unit that receives light of the flash from the fixing unit to emit light.

### TECHNICAL FIELD

The present invention relates to a light emitting accessory for a portable terminal and an accessory light emitting system for a portable terminal, and to a light emitting accessory for a portable terminal, which is detachably coupled to the portable terminal to emit light using light of a flash of the portable terminal based on an external signal, a location of the portable terminal, and the like, and an accessory light emitting system for a portable terminal.

### BACKGROUND ART

A portable terminal such as a smartphone is variously used in real lives, for example, wireless Internet, capturing of a picture, a game, and the like in addition to a voice communication function. Various accessories related to the portable terminal have been also released and used together with such a portable terminal. A representative example is a protection case for protecting a portable terminal.

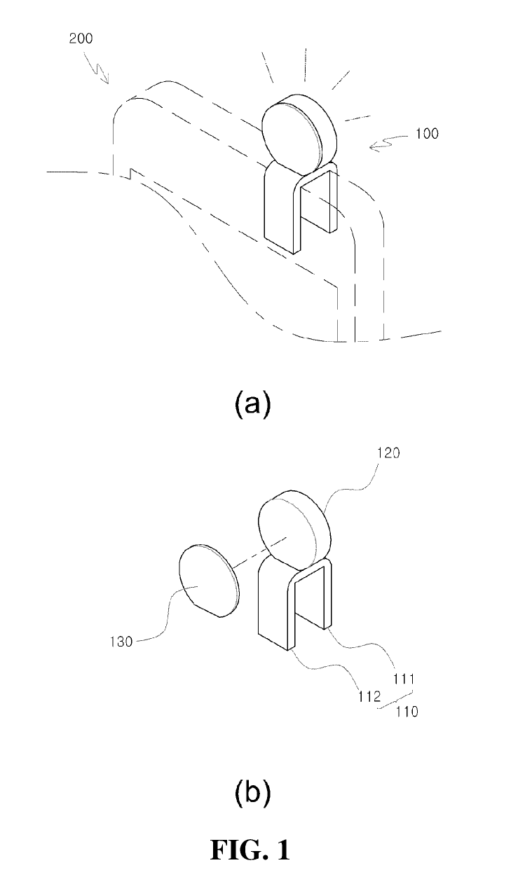

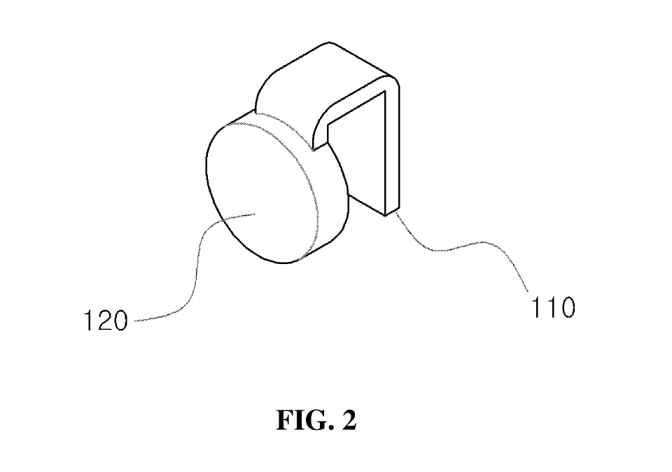

In addition to the protection case for a portable terminal, Korean Utility Model Application Publication No. 20-2013-0007344 discloses an accessory for a portable terminal. FIG. 1 is a perspective view illustrating a use state of an accessory for a portable terminal according to the related art, and FIG. 2 is an exploded perspective view illustrating a structure of the accessory for a portable terminal according to the related art. The accessory for a portable terminal according to the related art, which emits light when an impact is applied to an earphone connector for a portable terminal or the portable terminal is shaken, is conceived such that a beauty of the portable terminal may make good and an outer appearance of the portable terminal may be decorated variously according to tastes of a user.

Such an accessory for a portable terminal according to the related art includes an earphone connecting port 104 that is formed below a body 102 such that the accessory may used while being inserted into an earphone connector of a portable terminal 200 and a light emitting diode (LED) 24 that is provided in the body 102 to emit light at the impact or the shaking. Further, a printed circuit board (PCB) substrate 18 and a plurality of batteries 22 are installed in the body 102.

However, the accessory for a portable terminal according to the related art has problems in that because the LED 24, the PCB substrate 18, and batteries 22 for a light emitting function should be installed in the body 102, a structure thereof is complex and manufacturing costs thereof are increased.

### DISCLOSURE

### [Technical Problem]

The present invention is conceived to solve the above-described problems, and an aspect of the present invention is to provide a light emitting accessory for a portable terminal, in which a separate light source and a separate power source are not required and a structure thereof is simple.

### [Technical Solution]

To achieve the aspect, a light emitting accessory for a portable terminal according to the present invention may include: a fixing unit that is detachably coupled to a portable terminal to cover a flash that is formed on a rear surface of the portable terminal; and a light emitting unit that receives light of the flash from the fixing unit to emit light.

Further, the fixing unit may include a first fixing part that covers the flash, and a second fixing part that is formed integrally with the first fixing part to surround the portable terminal and covers a portion of a front surface of the portable terminal to elastically press the portable terminal together with the first fixing part, wherein the light emitting unit may protrude from the fixing unit.

Further, the fixing unit and the light emitting unit may be integrally formed and may be bent to surround the portable terminal, and the light emitting unit may cover the portion of the front surface of the portable terminal to elastically press the portable terminal together with the fixing unit.

Further, the light emitting accessory for a portable terminal according to the present invention may further include an advertisement unit that is attached to the light emitting unit.

Meanwhile, a light emitting system of a light emitting accessory for a portable terminal according to the present invention, the light emitting accessory including a fixing unit that is detachably coupled to a portable terminal to cover a flash that is formed on a rear surface of the portable terminal, and a light emitting unit that receives light of the flash from the fixing unit to emit light, may include: a signal detecting unit that detects an external signal; a control unit that operates the flash when the signal detecting unit detects the signal; and the light emitting accessory that emits light based on an operation of the flash.

Further, the signal detecting unit may be a short-range wireless communication module that wirelessly accesses a communication device that is installed in a predetermined place to transmit/receive information, and when the portable terminal is moved within an accessible range of the communication device and the short-range wireless communication module, the flash may be operated so that the light emitting accessory may emit light.

Further, the short-range wireless communication module may be a beacon module or a Wi-Fi module.

Further, the signal detecting unit may be a GPS reception module, and when the portable terminal arrives at a predetermined location, the flash may be operated so that the light emitting accessory may emit light.

Further, a light emitting system of a light emitting accessory for a portable terminal according to the present invention may include a control unit that operates the flash in conjunction with application software that is installed in the portable terminal; and the light emitting accessory that emits light based on an operation of the flash.

Further, the application software may be software for performing an alarm or notifying of state information of the portable terminal, and the control unit may operate the flash based on setting of the alarm or the state information of the portable terminal.

Further, the application software may be music reproduction software or a game, and the control unit may allow the flash to flicker in accordance with music that is reproduced in the portable terminal or a game situation.

Further, the control unit may change a light emitting pattern of the light emitting accessory by adjusting a flickering speed of the flash.

### [Advantageous Effects]

A light emitting accessory for a portable terminal according to the present invention does not require a separate light source and a separate power source because a flash of a portable terminal is used, a structure thereof is simple, and manufacturing costs are low.

Further, the light emitting accessory may be coupled to or separated from the portable terminal regardless of types of portable terminals.

Further, the light emitting accessory for a portable terminal according to the present invention may emit light to perform a notification function according to setting of a user when receiving a message or arriving at a specific place.

Further, the light emitting accessory for a portable terminal according to the present invention may flicker in accordance with music that is reproduced by the portable terminal.

### DESCRIPTION OF THE INVENTION

FIG. 1 is a perspective view illustrating a use state of an accessory for a portable terminal according to the related art;

FIG. 2 is an exploded perspective view illustrating a structure of the accessory for a portable terminal according to the related art;

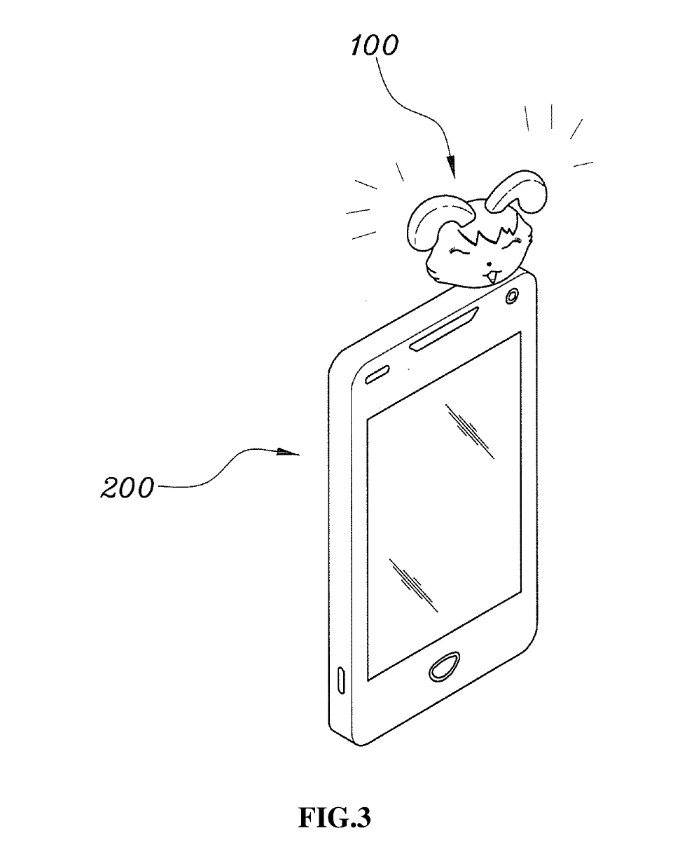

FIG. 3 is a perspective view illustrating a light emitting accessory for a portable terminal according to a first embodiment of the present invention; and

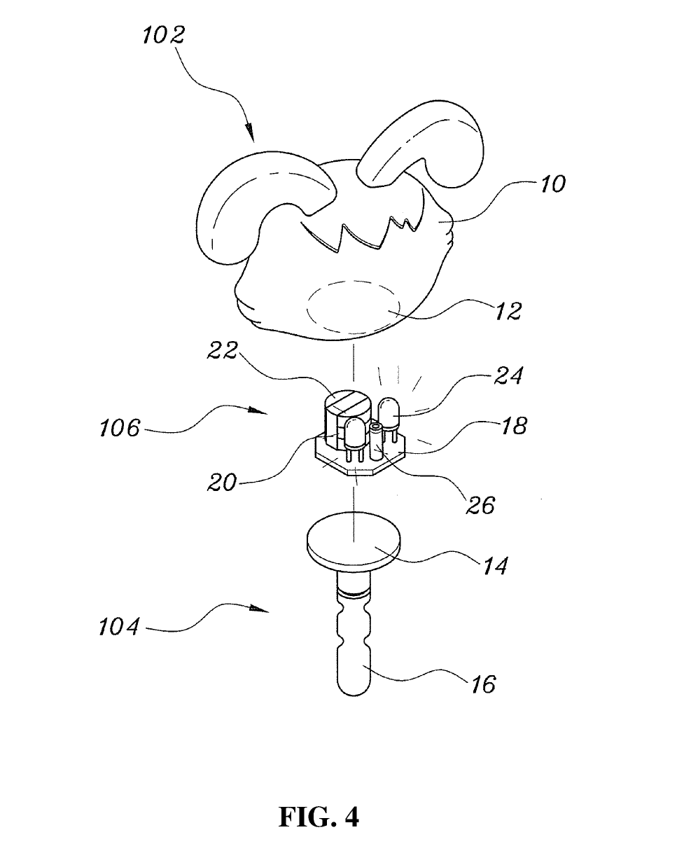

FIG. 4 is a perspective view illustrating a light emitting accessory for a portable terminal according to a second embodiment of the present invention.

### BEST MODE

The present invention relates to a light emitting accessory for a portable terminal, which is detachably coupled to a portable terminal to emit light using light of a flash of the portable terminal based on an external signal, a location of the portable terminal, and the like, and a light emitting system of an accessory for a portable terminal. A separate light source and a separate power source are not required, a structure thereof is simple, and manufacturing costs thereof are low. Further, the light emitting accessory may be easily coupled to or separated from the portable terminal regardless of types of portable terminals, and may emit light to perform a notification function according to setting of a user when receiving a message or arriving at a specific place. Hereinafter, respective embodiments of the present invention will be described in detail with reference to the accompanying drawings.

### First Embodiment

As illustrated in FIG. 3, a light emitting accessory for a portable terminal according to a first embodiment of the present invention includes a fixing unit 110, a light emitting unit 120 and an advertisement unit 130. FIG. 3A is a perspective view illustrating a state in which a portable terminal 200 and a light emitting accessory 100 are coupled to each other, and FIG. 3B is a perspective view illustrating the light emitting accessory 100 in which the advertisement unit is separated therefrom.

The fixing unit 110 is detachably coupled to the portable terminal 200 to cover a flash that is formed on a rear surface of the portable terminal 200, and the light emitting unit 120 receives light of the flash from the fixing unit 110 to emit light. The fixing unit 110 and the light emitting unit 120 are manufactured of a transparent or semi-transparent material having various colors, and the light of the flash is transferred to the light emitting unit 120 through the fixing unit 110 according to an operation of the flash so that the light emitting unit 120 emits light. The fixing unit 110 transfers a portion or the entirety of the light to the light emitting unit 120 using characteristics that light is totally or irregularly reflected therein. Such a fixing unit 110 may be coupled to any one of lateral surfaces of the portable terminal 200 based on a location of the flash or regardless of the location of the flash.

In detail, the fixing unit 110 includes a first fixing part 111 and a second fixing part 112 that are formed integrally with each other and are bent to surround the portable terminal 200. Such a first fixing part 111 covers the flash, and the second fixing part 112 covers a portion of a front surface of the portable terminal 200. Further, the first fixing part 111 and the second fixing part 112 are coupled to the portable terminal 200 as the portable terminal 200 is elastically pressed. Meanwhile, an escape part for preventing a camera lens of the portable terminal 200 from being covered may be formed in the first fixing part 111. The fixing unit 110 having the above-described structure may be coupled to the portable terminal 200 having various shapes and sizes. The fixing unit 110 may have various structures that may be attached to and detached from the portable terminal 200 while transferring the light of the flash to the light emitting unit 120, in addition to the above-described coupling structure.

The light emitting unit 120 may be manufactured to protrude from the fixing part 110 and to have various shapes. That is, the light emitting unit 120 is formed to have a specific character shape as well as a general shape such as a circular shape and a rectangular shape to decorate or characterfully represent an outer appearance of the portable terminal 200 by itself. Meanwhile, in the present embodiment, the light emitting unit 120 is formed integrally with the fixing unit 110 but is formed to have a structure that may be assembled with the fixing unit 110, and thus, the light emitting unit 120 may be replaced based on tastes of the user. Further, the light emitting unit 120 may have a rotatable structure such that it may be rotated.

The advertisement unit 130 has a trademark, a logo, a character and the like for advertisement, which are displayed thereon, and is attached to the light emitting unit 120. Further, the advertisement unit 130 may have a specific figure, a letter, a number, a picture and the like that are displayed thereon. Such an advertisement unit 130 may be excluded from configuration of the present invention based on various embodiments of the present invention.

### Second Embodiment

A light emitting accessory for a portable terminal according to a second embodiment of the present invention includes a fixing unit 110, a light emitting unit 120 and an advertisement unit 130, as illustrated in FIG. 4. In FIG. 4, the advertisement unit 130 is not separately illustrated, and may be included in configurations of the present invention as described in the first embodiment or may be excluded from the configurations of the present invention.

The fixing unit 110 is detachably coupled to the portable terminal 200 to cover a flash that is formed on a rear surface of the portable terminal 200, and the light emitting unit 120 receives light of the flash from the fixing unit 110 to emit light. Such a fixing unit 110 and a light emitting unit 120 may be manufactured of a transparent or semi-transparent material, and the light of the flash is transferred to the light emitting unit 120 through the fixing unit 110 based on an operation of the flash so that the light emitting unit 120 emits light.

In detail, the fixing unit 110 and the light emitting unit 120 are formed integrally with each other and are bent to surround the portable terminal 200, and the light emitting unit 120 covers a portion of a front surface of the portable terminal 200 and elastically presses the portable terminal 200 together with the fixing unit 110. Accordingly, the light emitting unit 120 is located on a front surface of the portable terminal 200.

The second embodiment is identical to the first embodiment except for the above-described configurations.

Next, a light emitting system of a light emitting accessory for a portable terminal according to the present invention will be described.

An accessory light emitting system according to an embodiment of the present invention includes a signal detecting unit, a control unit and the light emitting accessory 100.

The signal detecting unit is included in the portable terminal 200 and detects an external signal. The control unit operates the flash when the signal detecting unit detects the signal. The light emitting accessory 100 is manufactured of a transparent or semi-transparent material as described above, and emits light by the light of the flash based on the operation of the flash.

Here, the control unit may change a light emitting pattern of the light emitting accessory 100 by adjusting a flickering speed of the flash based on a predetermined condition.

In detail, the signal detecting unit is a short-range wireless communication module that transmit/receives information while wirelessly accessing a communication device that is installed in a predetermined place in advance. When the portable terminal 200 is moved within an accessible range of a communication device and the short-range wireless communication module, the flash is operated so that the light emitting accessory 100 emits light. Examples of the short-range wireless communication module include a beacon module, a Wi-Fi communication module, and the like. That is, when wirelessly accessing the communication device to transmit/receive information, the beacon module transmits an access signal to the control unit, and the flash is operated by the control unit. When accessing a predetermined Wi-Fi communication network, the Wi-Fi communication module transfers an access signal to the control unit, and the flash is operated by the control unit.

Further, the signal detecting unit may be a GPS reception module. Accordingly, when the GPS reception module receives location information and the portable terminal 200 arrives at a predetermined location, the flash is operated by the control unit.

As well, the flash is operated by a message that is received by the portable terminal 200, or the like so that the light emitting accessory 100 may emit light.

Further, the light emitting accessory 100 for a portable terminal may emit light in conjunction with application software that is installed in the portable terminal 200.

In detail, the light emitting system of the light emitting accessory that works in conjunction with the application software includes a control unit that operates the flash in conjunction with the application software that is installed in the portable terminal 200, and the light emitting accessory 100 that emits light based on the operation of the flash.

Such application software is software for performing an alarm or notifying of state information of a portable terminal, and the control unit operates the flash based on setting of the alarm or the state information (residual amount of battery, antenna receiver, and the like) of the portable terminal.

Further, the application software is music-reproducing software, and the control unit allows the flash to flicker in accordance with music that is reproduced by the portable terminal. Accordingly, when the music is reproduced by the portable terminal, the music is output and, at the same time, the light emitting accessory 100 emits light in accordance with the music.

In addition, the application software is various kinds of software such as a game, and the control unit allows the flash to flicker in accordance with characteristics of each piece of application software, so that the light emitting accessory 100 may emit light.

The light emitting accessory for a portable terminal and the light emitting system of the light emitting accessory for a portable terminal according to the present invention are not limited to the above-described embodiments, and may be variously modified within the scope of the technical spirit of the present invention.

1. A light emitting accessory for a portable terminal, the light emitting accessory comprising:
a fixing unit that is detachably coupled to a portable terminal to cover a flash that is formed on a rear surface of the portable terminal; and
a light emitting unit that receives light of the flash from the fixing unit to emit light.

2. The light emitting accessory of claim 1, wherein the fixing unit comprises:
a first fixing part that covers the flash; and
a second fixing part that is formed integrally with the first fixing part, is bent to surround the portable terminal, covers a portion of a front surface of the portable terminal, and elastically presses the portable terminal together with the first fixing part,
wherein the light emitting unit protrudes from the fixing unit.

3. The light emitting accessory of claim 1, wherein the fixing unit and the light emitting unit are integrally formed and are bent to surround the portable terminal,
wherein the light emitting unit covers the portion of the front surface of the portable terminal and elastically presses the portable terminal together with the fixing unit.

4. The light emitting accessory of claim 1, further comprising:
an advertisement unit that is attached to the light emitting unit.

5. A light emitting system of a light emitting accessory for a portable terminal, the light emitting accessory comprising a fixing unit that is detachably coupled to a portable terminal to cover a flash that is formed on a rear surface of the portable terminal, and a light emitting unit that receives light of the flash from the fixing unit to emit light, and the light emitting system comprising:
a signal detecting unit that detects an external signal;
a control unit that operates the flash when the signal detecting unit detects the signal; and
the light emitting accessory that emits light based on an operation of the flash.

6. The light emitting system of claim 5, wherein the signal detecting unit is a short-range wireless communication module that wirelessly accesses a communication device that is previously installed in a predetermined place to transmit/receive information, and wherein when the portable terminal is moved within an accessible range between the communication device and the short-range wireless communication module, the flash is operated so that the light emitting accessory emits light.

7. The light emitting system of claim 6, wherein the short-range wireless communication module is a beacon module or a Wi-Fi communication module.

8. The light emitting system of claim 5, wherein the signal detecting unit is a GPS reception module, and
wherein when the portable terminal arrives at a predetermined location, the flash is operated so that the light emitting accessory emits light.

9. A light emitting system of a light emitting accessory for a portable terminal, the light emitting accessory comprising a fixing unit that is detachably coupled to a portable terminal to cover a flash that is formed on a rear surface of the portable terminal, and a light emitting unit that receives light of the flash from the fixing unit to emit light, and the light emitting system comprising:
a control unit that operates the flash in conjunction with application software that is installed in the portable terminal; and
a light emitting accessory that emits light based on an operation of the flash.

10. The light emitting system of claim 9, wherein the application software is software for performing an alarm or notifying of state information of the portable terminal, and
wherein the control unit operates the flash based on setting of the alarm or the state information of the portable terminal.

11. The light emitting system of claim 9, wherein the application software is music reproduction software or a game, and
wherein the control unit allows the flash to flicker in accordance with music reproduced by the portable terminal or a game situation.

12. The light emitting system of claim 5, wherein the control unit changes a light emitted pattern of the light emitting accessory by adjusting a flickering speed of the flash.

13. The light emitting system of claim 9, wherein the control unit changes a light emitted pattern of the light emitting accessory by adjusting a flickering speed of the flash.
